(19) United States
(12) Patent Application Publication
(10) Pub. No.: US 2011/0108679 A1
(43) Pub. Date: May 12, 2011

(54) Pro fencer brace system

(76) Inventors: Charles L. Bullock, Inez, TX (US); Joe "Cuatro" Stack, IV, El Campo, TX (US)

(21) Appl. No.: 12/804,802

(22) Filed: Jul. 28, 2010

Related U.S. Application Data
(60) Provisional application No. 61/273,113, filed on Jul. 31, 2009.

(51) Int. Cl. F16L 3/08; F16M 13/02; F16M 13/00

(52) U.S. Cl. 248/65; 248/218.4; 248/219.4; 248/309.1

(57) ABSTRACT

The “Pro Fencer Brace System” is basically a metal insert and clamp that act as a multi-angular receiver for compression or tension bracing on game or livestock fencing.

### BRIEF SUMMARY OF THE INVENTION

The invention known as “PRO FENCER BRACE SYSTEM” is unique in it's configuration and design. It was developed to be more flexible and lower cost in application than previous systems. It is capable of multiple applications as a bracing support component for commercial, residential, game and security fencing.

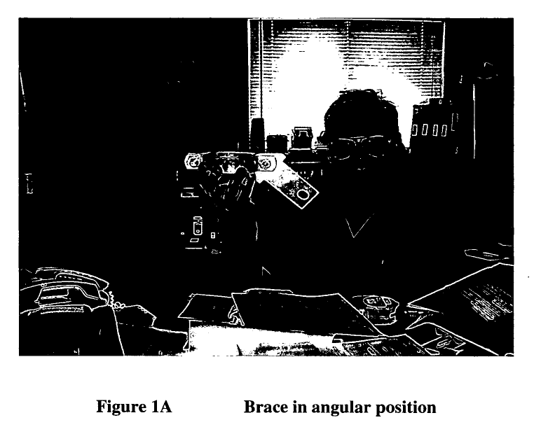

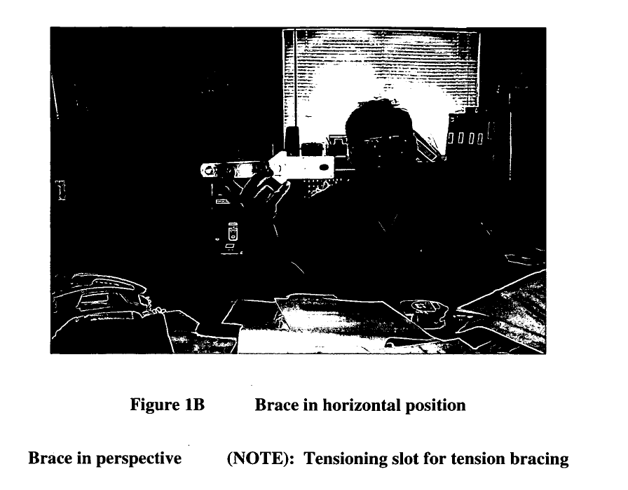

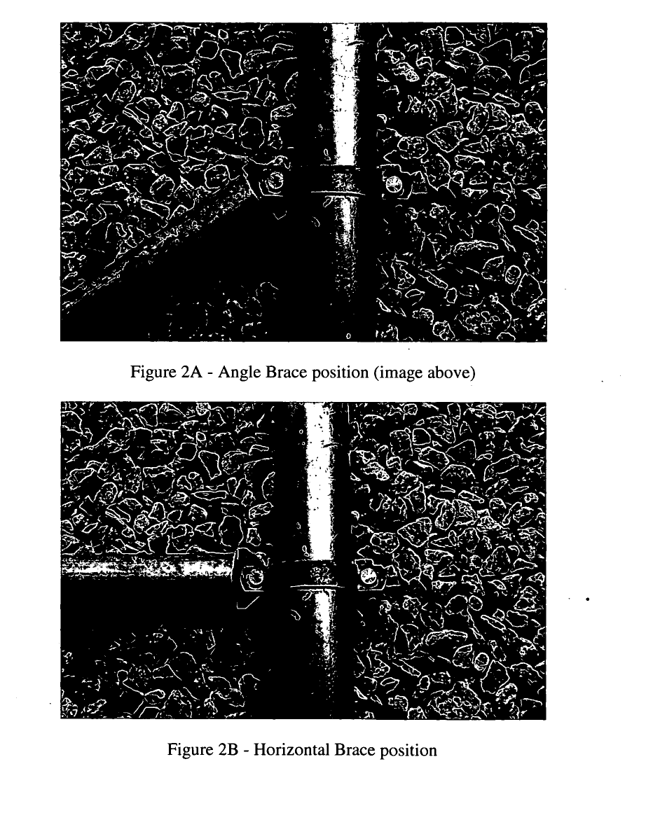

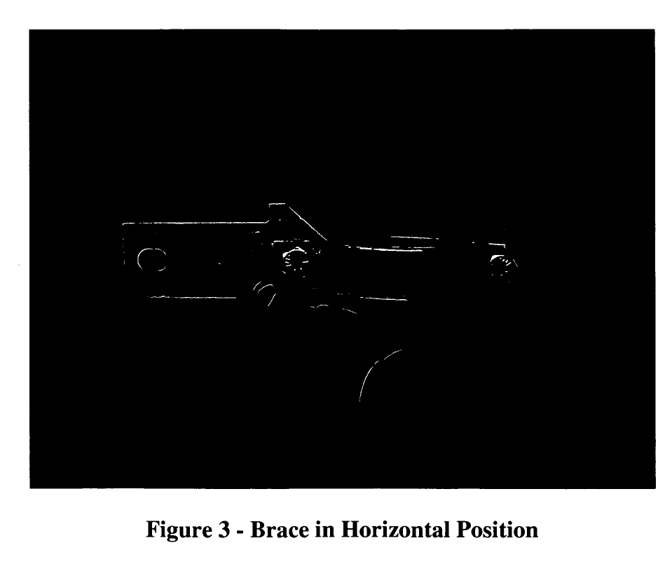

To use the “Pro Fencer Brace” in the angular position, you first set 2″ to 6″ wood or metal posts 2-4 ft. in the ground, secure the post base and fasten a “Pro Fencer” clamp, insert approximately at the point that is 75% of the total height of the post and one at approximately 6″ from the ground on the next post. Measure and cut a section of approximately 2″ pipe material to fit on the two opposing tabs of the inserts and loosen the-top Pro Fencer clamp enough to slide it so that the pipe that was cut to fit will slide onto the two opposing insert tabs. Then slide the top Pro Fencer clamp down to remove any slack and tighten clamp. You now have an angular compression brace. (See “FIG. 2A” Page 12)

To secure in a tension mode fasten clamps as in chapter 0002 and instead of using pipe to push, utilize braided steel ⅜″ cable attached to the tension slots in the Pro Fencer insert near the top of one post to pull a tension using the other set post and “Pro Fencer” insert near the bottom of that post as the anchor.

To secure a tension or compression brace in horizontal mode, fasten the “Pro Fencer Braces” at the same height on posts set next to each other.

### BACKGROUND OF THE INVENTION

Typically, in the fencing industry, fence strength is enhanced by angle and horizontal bracing of the individual or series of posts.

Problems encountered:

1) Post bracing that is welded in the field poses a fire hazard as well as requiring welding equipment to be transported over rough terrain.

2) Prior Art bracing fixtures are cast at fixed angles which limit the way that fences can be configured in rugged terrain.

### BRIEF SUMMARY OF THE INVENTION

The “PRO FENCER BRACE SYSTEM” is much more versatile in the field and is more accommodating to the game fencing industry than any previous bracing system. It fulfills the higher strength requirements of increasingly taller fencing structures.

This system bracket is capable of compression and tension bracing at multiple angles and works for posts or pipe with diameters ranging from 2 inches to over 6 inches.

The “Pro Fencer Brace System” needs no welding therefore eliminating the fire hazard and logistical problems associated with welding equipment.

Because the “Pro Fencer Brace System” is not rigidly cast, it works at more angles than previous systems, with increased versatility in difficult terrain.

### DETAILED DESCRIPTION OF THE INVENTION

The Pro Fencer Brace System consists of a “Post Clamp” and a “Horizontal and/or Angular Support insert”, whereas the “Support Insert” is unique and previously did not exist.

“The Post Clamp” is a common hardware item used in commercial and residential fencing composed of ¼″ to ½″ metal plate material shaped to fit in pairs around a 2″ to 6″ metal fence pipe or wood post with holes on both sides to accommodate bolts to immobilize said post or pipe. This allows the support insert to be pivoted 360°

The “Horizontal and/or Angular Support Insert” is a unique device used to create a support connection that can be used as a “compression” or push type of support or it can be used as a “tension” or pull type support. It is made by punch pressing or cutting ¼″ to ½″ extruded metal in the unique “arrow” shape or mushroom shape, thus accommodating multiple angles of usefulness in uneven terrains encountered in fence building. Two ⅜″ slots are machined or punched to allow for the bolts used to fasten and tension this unique insert.

The Pro Bracer Insert is capable of multiple angle bracing that previous systems that are cast metal and are therefore rigid, not capable of adjustment to different angle requirements of modern fence building.

The Pro Fencer system replaces welded metal bracing, therefore eliminating the fire hazard and inconvenience of welding in remote areas.

1) A unique fence post bracket used to secure a pipe brace for strengthening a game or livestock fence.

2) A fence bracket (according to claim 1) constructed to receive a metal pipe with an I.D. of 2″ to 6″ that constitutes the brace.

3) Bracket consists of a post clamp and support insert. (See “Drawing A” page 20)

4) Post clamp consists of two matching extruded ¼″ to ½″×1″ to 3″ wide (metal or other material) pieces formed to fit around a 2″ to 6″ O.D. metal or wood post to anchor the Pro Fencer insert to the post. (See Drawing “C” page 22)

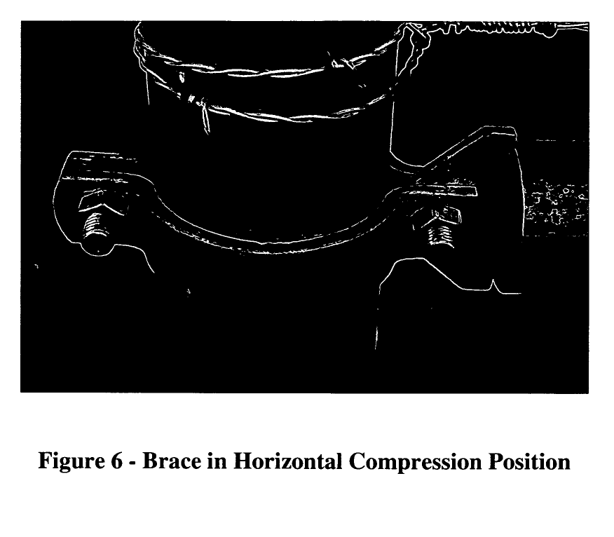

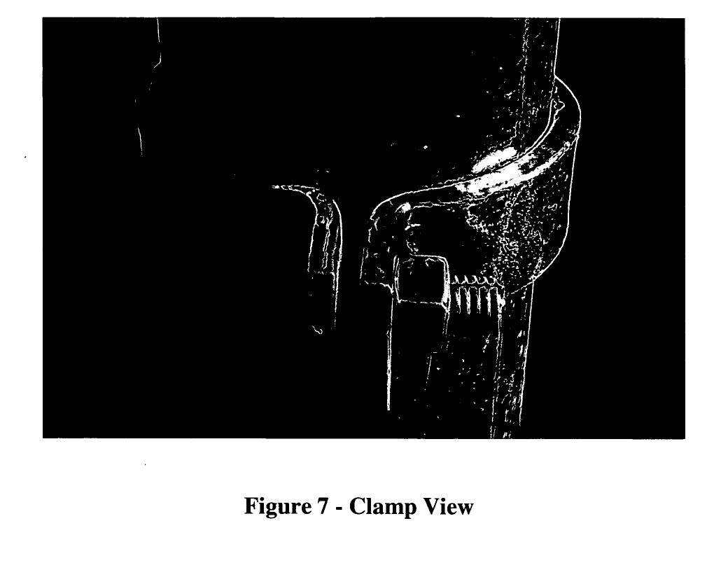

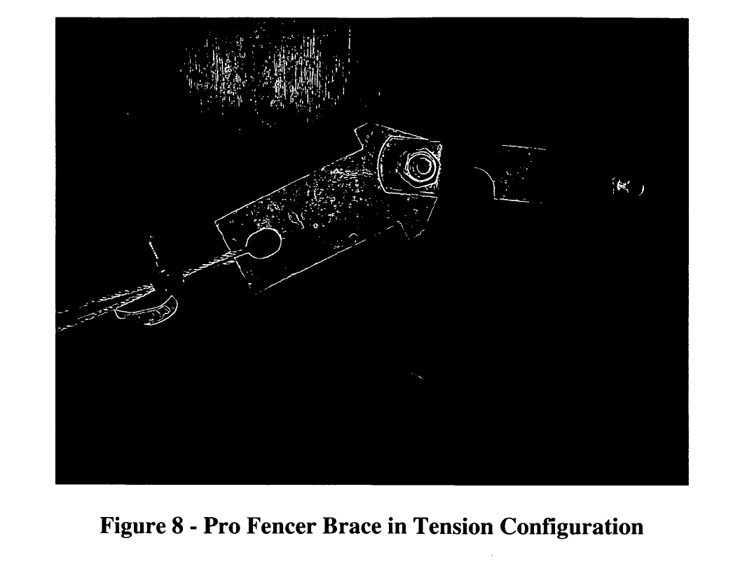

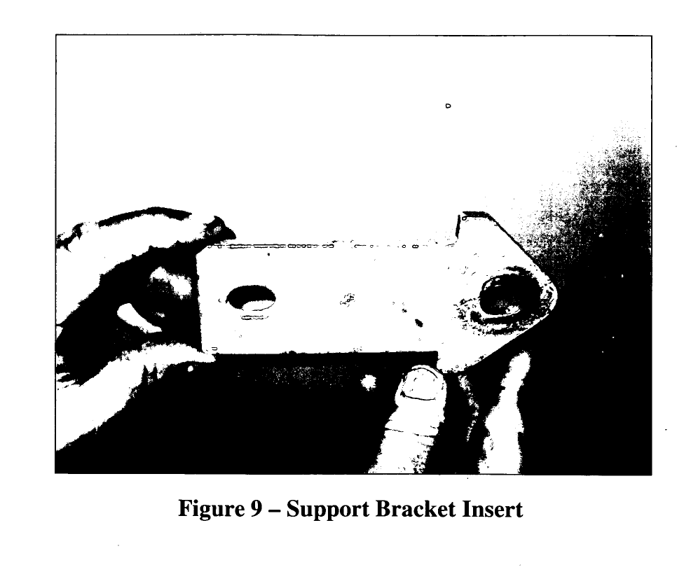

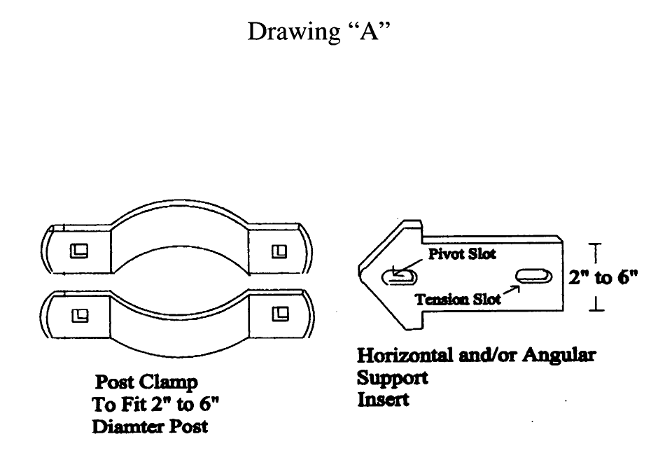

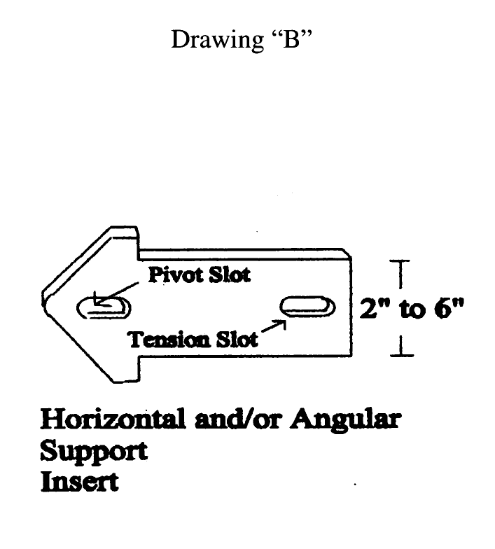

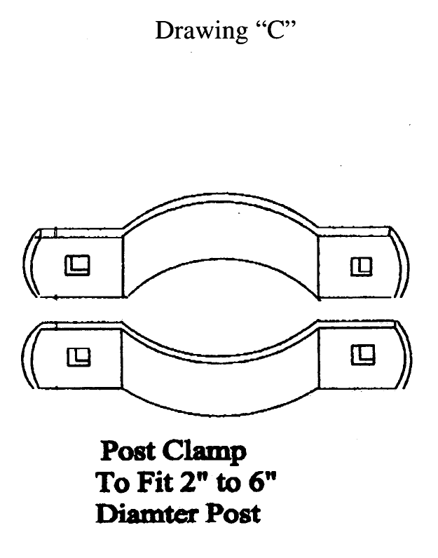

5) The metal fence post clamp and support bracket insert are made of ¼″ to ½″ thick extruded metal. (See “Figure 6” page 16and “Figure 9” page 19)

6) Bracket system can be use for compression or tension support. (See “Drawing A” Page 20)

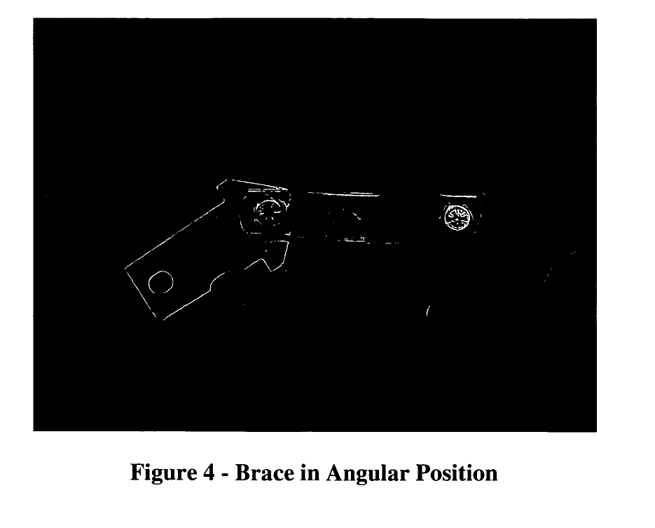

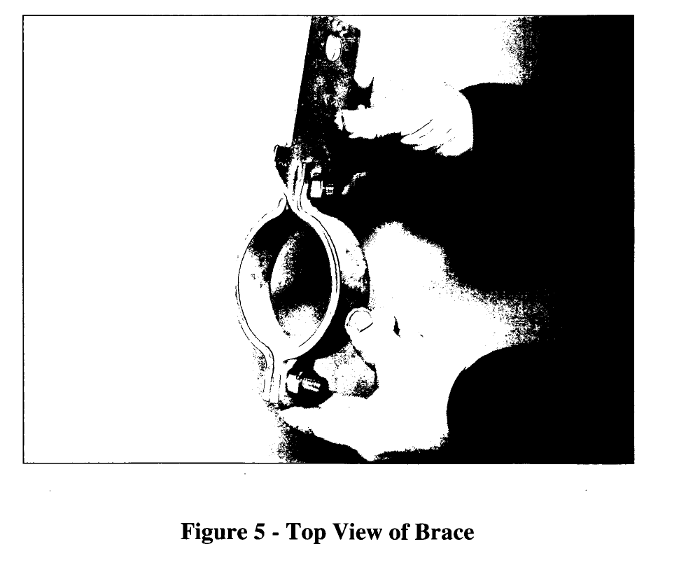

7) Support insert is bolted to post clamp and fence tubing is inserted to push against support shoulders for compression bracing. (See “FIG. 2A”, “FIG. 2B” page 12 and “FIG. 4” Page 14)

8) Support system, according to claim 7) can be used in an angular or horizontal position. (See “Brief Description of Several Views” Pages 10, 11,12,13,14,15,16,17 and 18)
